(19) United States
(12) Patent Application Publication
(10) Pub. No.: US 2026/0291110 A1
(43) Pub. Date: Sep. 24, 2026

(54) CONNECTOR

(71) Applicant: YAZAKI CORPORATION, Tokyo (JP)

(72) Inventors: Kotatsu Shibayama, Kakegawa-shi (JP); Yoshitaka Tsushima, Kakegawa-shi (JP); Shoya Ueda, Kakegawa-shi (JP)

(21) Appl. No.: 19/545,028

(22) Filed: Feb. 20, 2026

(30) Foreign Application Priority Data
Mar. 19, 2025 (JP) 2025-045551

(51) Int. Cl. H01R 13/434; H01R 24/20

(52) U.S. Cl. CPC H01R 13/434; H01R 24/20

(57) ABSTRACT

A connector includes a holding mechanism that holds a terminal holder inside a rear case. The holding mechanism includes a fitting recess into which the terminal holder is fitted inside the rear case, a locking portion provided on one of the terminal holder and the rear case, and a locking-subjected portion provided on the other of the terminal holder and the rear case. The locking portion is locked to the locking-subjected portion in a state where the terminal holder is fitted into the fitting recess, and a locked state of the locking portion with respect to the locking-subjected portion is released by flexibly deforming the terminal holder.

### BACKGROUND OF THE INVENTION

### Field of the Invention

Aspects of the present invention relate to a connector.

Priority is claimed on Japanese Patent Application No. 2025-045551 filed in Japan on Mar. 19, 2025, the content of which is incorporated herein by reference.

### Description of Related Art

For example, a wide variety of electronic devices are mounted on an automobile as a moving body. In an automobile, electrical connection with an electronic device is performed via a connector in order to transmit power, a control signal, and the like to the electronic device.

In general, a connector includes a housing including a cylindrical fitting portion that protrudes in a cylindrical shape in a direction in which the connector is fitted to a mating connector, a terminal having a tip end side held inside the cylindrical fitting portion, and an electric wire cord having one end side joined to a base end side of the terminal and the other end side led out to the outside of the housing through a hole portion provided in the housing.

For example, a connector described in Patent Document 1 includes a connector housing provided with a terminal fitting and a terminal accommodating chamber, and a rear holder attached to an end portion of the connector housing on a side away from a mating connector. The terminal accommodating chamber includes a connection portion accommodating portion that accommodates an electric wire connection portion of the terminal fitting, a contact portion accommodating portion that is continuous with the connection portion accommodating portion and accommodates an electrical contact portion of the terminal fitting and is smaller than the connection portion accommodating portion, and a step surface formed between the connection portion accommodating portion and the contact portion accommodating portion. The electric wire connection portion of the terminal fitting is provided with a flange portion that protrudes from the outer peripheral surface of the electric wire connection portion and can come into contact with the step surface. A sleeve member is accommodated in the connection portion accommodating portion of the terminal accommodating chamber and is provided between the flange portion and the rear holder.

### Citation List

### Patent Document

Patent Document 1: Japanese Unexamined Patent Application, First Publication No. 2010-055809

### SUMMARY OF THE INVENTION

Incidentally, in the connector of the related art, a terminal holder holding a terminal is attached to a housing from the back side of a housing via a lock mechanism.

However, since the lock mechanism of the terminal holder is exposed to the outside of the housing, the lock mechanism may be released or the lock mechanism may be damaged due to an influence from the outside.

In this case, it is difficult to hold the terminal inside the housing in a stable state, and the robustness of the connector is deteriorated.

On the other hand, when the terminal holder is removed from the housing in a connector production process or the like, a dedicated jig is required to release the lock mechanism, and thus assembling workability of the terminal holder is deteriorated.

An aspect of the present invention provides a connector capable of holding a terminal in a stable state and improving assembling workability of a terminal holder holding the terminal.

A connector of the present invention includes a housing including a cylindrical fitting portion that protrudes in a cylindrical shape in a direction in which the connector is fitted to a mating connector, a rear case assembled on a side opposite to the cylindrical fitting portion of the housing, a terminal holder disposed between the housing and the rear case, a terminal of which a tip end side is held inside the cylindrical fitting portion in a state where a base end side of the terminal is held by the terminal holder, and a holding mechanism that holds the terminal holder inside the rear case. The holding mechanism includes a fitting recess into which the terminal holder is fitted inside the rear case, a locking portion provided on one of the terminal holder and the rear case, and a locking-subjected portion provided on the other of the terminal holder and the rear case. The locking portion is locked to the locking-subjected portion in a state where the terminal holder is fitted into the fitting recess, and a locked state of the locking portion with respect to the locking-subjected portion is released by flexibly deforming the terminal holder.

In the connector according to the aspect of the present invention, it is possible to hold the terminal in a stable state and improve assembling workability of the terminal holder holding the terminal.

### BRIEF DESCRIPTION OF THE DRAWINGS

FIG. 1 is a perspective view illustrating a constitution of a connector according to an embodiment of the present invention.

FIG. 2 is an exploded perspective view illustrating the constitution of the connector illustrated in FIG. 1.

FIG. 3 is a perspective view illustrating a state before a housing and a rear case of the connector illustrated in FIG. 1 are assembled.

FIG. 4 is a cross-sectional view illustrating a state before the housing and the rear case of the connector illustrated in FIG. 3 are assembled.

FIG. 5 is an enlarged cross-sectional view of a main part of the connector illustrated in FIG. 4.

FIG. 6 is a perspective view illustrating a state in which a connector terminal is held by a terminal holder.

FIG. 7 is a perspective view illustrating a state in which the terminal holder is held by the housing.

FIG. 8A is a front view illustrating a state before the terminal holder is flexibly deformed.

FIG. 8B is a front view illustrating a state after the terminal holder is flexibly deformed.

### DETAILED DESCRIPTION OF THE INVENTION

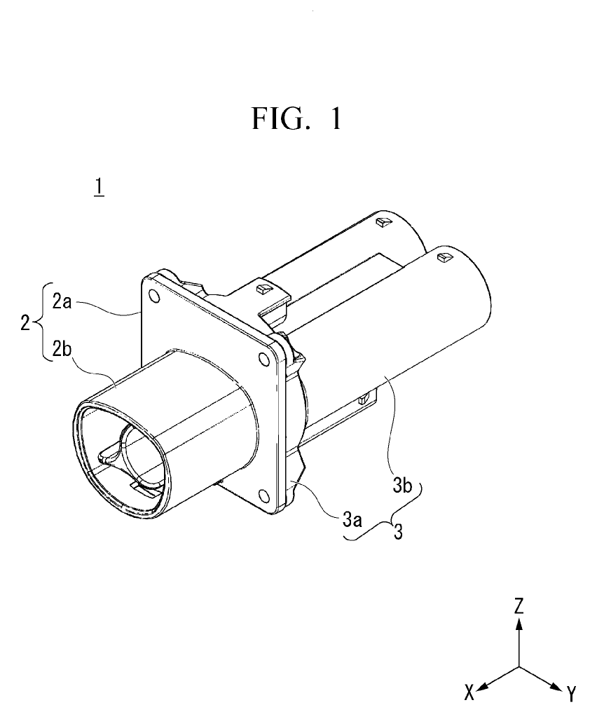

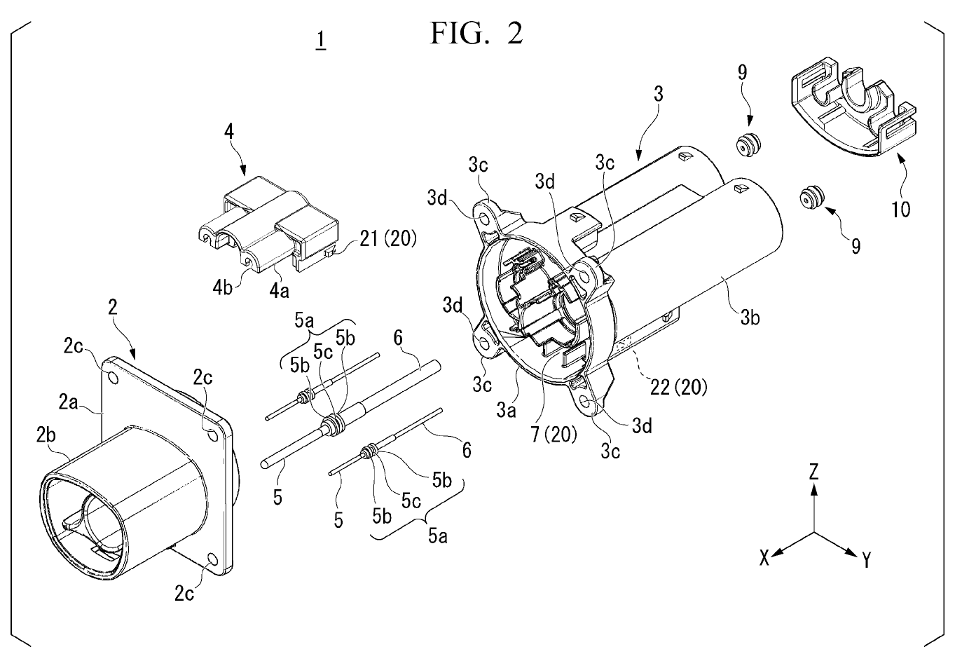

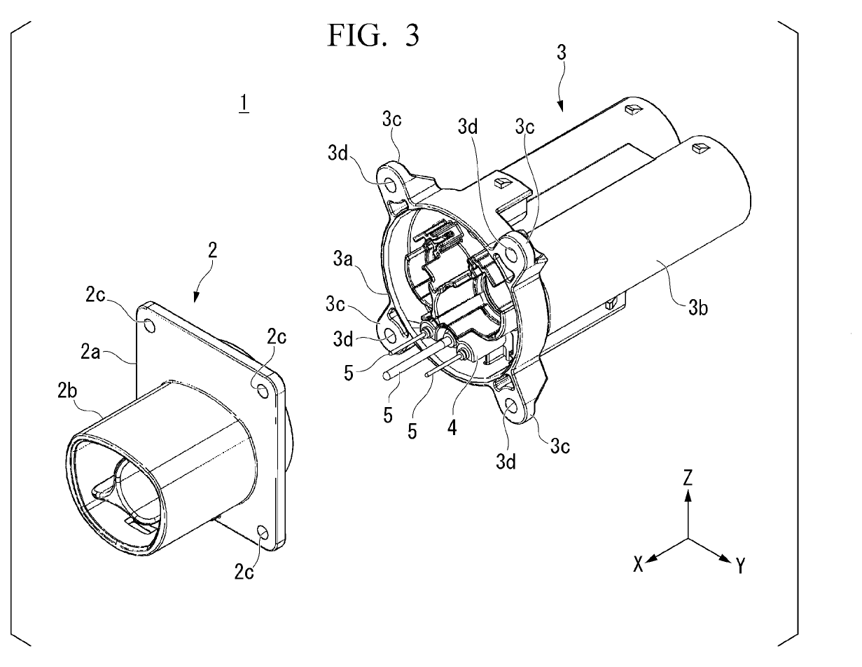

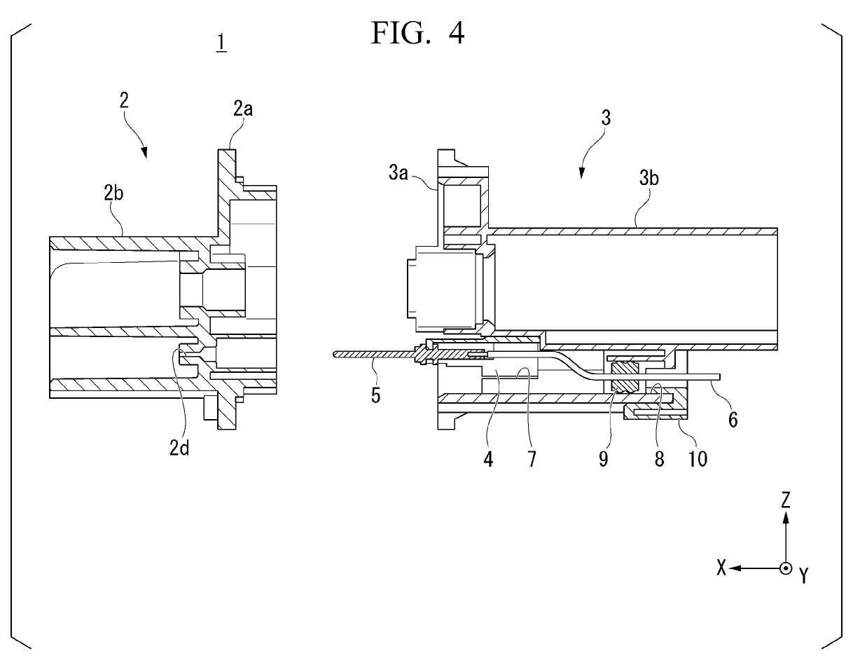

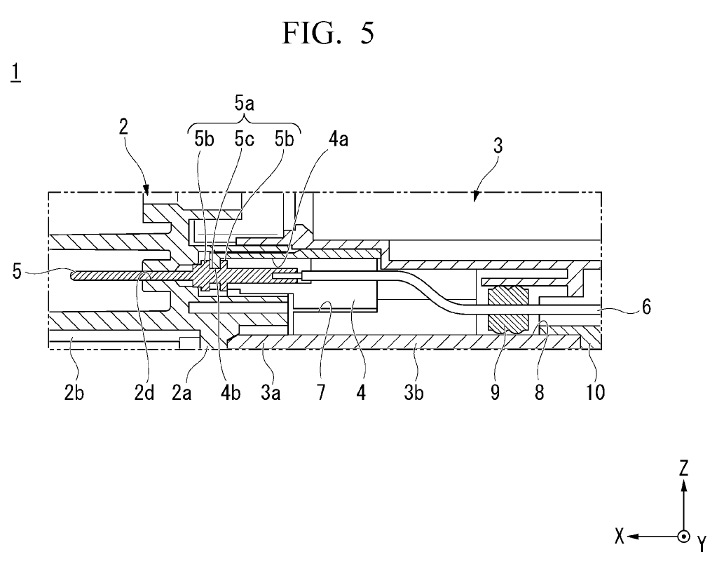

As an embodiment of the present invention, for example, a connector 1 illustrated in FIGS. 1 to 5 will be described. FIG. 1 is a perspective view illustrating a constitution of the connector 1. FIG. 2 is an exploded perspective view illustrating the constitution of the connector 1. FIG. 3 is a perspective view illustrating a state before a housing 2 and a rear case 3 of the connector 1 are assembled. FIG. 4 is a cross-sectional view illustrating a state before the housing 2 and the rear case 3 of the connector 1 are assembled. FIG. 5 is an enlarged cross-sectional view of a main part of the connector 1.

In addition, in the following drawings, an XYZ orthogonal coordinate system is set, and an X-axis direction is indicated as a front-rear direction of the connector 1, a Y-axis direction is indicated as a left-right direction of the connector 1, and a Z-axis direction is indicated as an up-down direction of the connector 1.

As illustrated in FIG. 1, the connector 1 of the present embodiment is fitted to a mating connector (not shown) to be electrically connected thereto. By electrically connecting the connectors to each other, electricity can be conducted between the connectors.

The connector 1 of the present embodiment constitutes a male (plug) connector to be inserted into a female (receptacle) connector, which is a mating connector.

In the present embodiment, a description will be given assuming that a first direction in which the connector 1 is inserted to the mating connector is a forward side (+X direction) of the connector 1, a direction opposite to the first direction is a rearward side (-X direction), a side facing the mating connector is the front side of the connector 1, and a side opposite thereto is the back side of the connector 1.

As illustrated in FIGS. 1 and 2, the connector 1 of the present embodiment includes the housing 2, the rear case 3, a terminal holder 4, a plurality of terminals 5, and a plurality of electric wire cords 6.

In the present embodiment, among the plurality of terminals 5 and electric wire cords 6, only three sets of terminals 5 and electric wire cords 6 held by the terminal holder 4 are illustrated.

As illustrated in FIGS. 1 to 4, the housing 2 is made of a molded body of a synthetic resin. The housing 2 has a back wall 2a constituting the back side thereof and a cylindrical fitting portion 2b constituting the front side thereof.

The back wall 2a is formed in a substantially rectangular flat plate shape with rounded corners. Four attachment holes 2c are provided at four corners of the back wall 2a so as to pass through the back wall 2a in the front-rear direction.

The cylindrical fitting portion 2b is a portion to be fitted with the above-described mating connector. The cylindrical fitting portion 2b protrudes in a substantially elongated cylindrical shape from a central portion on the front side of the back wall 2a.

A plurality of terminal holding portions 2d corresponding to the plurality of terminals 5 are provided inside the housing 2. The terminal holding portion 2d is a portion where a tip end side of the terminal 5 is held. The terminal holding portion 2d is located inside the cylindrical fitting portion 2b and provided to pass through the back wall 2a in the front-rear direction.

As illustrated in FIGS. 1 to 4, the rear case 3 is made of a molded body of a synthetic resin. The rear case 3 includes a cylindrical front portion 3a having a substantially cylindrical shape and constituting the front side thereof, a cord lead-out portion 3b extending rearward from the cylindrical front portion 3a, a plurality of fixing pieces 3c protruding in a radial expansion direction from an outer peripheral surface on the front side of the cylindrical front portion 3a, and screw holes 3d passing through the respective fixing pieces 3c in the front-rear direction.

A fitting recess 7 into which the terminal holder 4 is fitted is provided inside the cylindrical front portion 3a. In the cord lead-out portion 3b, a plurality of hole portions 8 are provided so as to pass through the inside of the rear case 3 in the front-rear direction corresponding to the plurality of electric wire cords 6.

Four fixing pieces 3c are provided corresponding to four corners of the back wall 2a constituting the housing 2. Four screw holes 3d are provided corresponding to the four attachment holes 2c of the housing.

The connector 1 of the present embodiment has a structure in which the housing 2 and the rear case 3 are integrated by screwing screws (not shown) into the screw holes 3d through the attachment holes 2c in a state in which the back side of the back wall 2a and the front side of the cylindrical front portion 3a are abutted with each other.

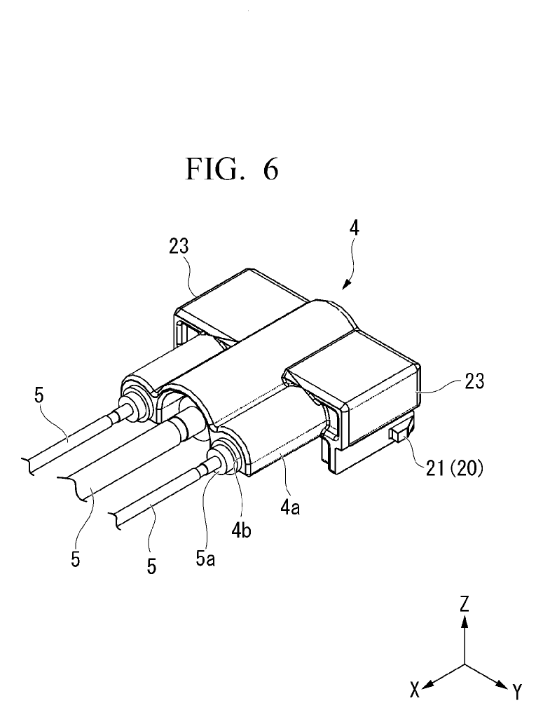

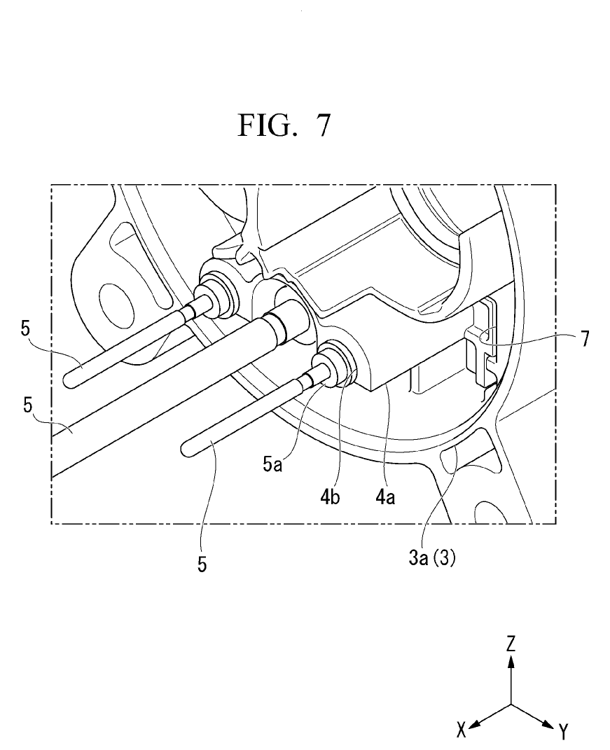

As illustrated in FIGS. 2 to 7, the terminal holder 4 is made of a molded body of a synthetic resin. In the terminal holder 4, a plurality of holding grooves 4a are provided so as to extend in the front-rear direction (the axial direction of the terminal 5) corresponding to the plurality of terminals 5. On the front side of the terminal holder 4, an engagement protrusion 4b protruding in a radial reduction direction from the inner peripheral surface of each holding groove 4a is provided.

The terminal holder 4 is held inside the fitting recess 7 via a holding mechanism 20. The holding mechanism 20 includes a locking portion 21 provided on one of the terminal holder 4 and the rear case 3 (the terminal holder 4 in the present embodiment) and a locking-subjected portion 22 provided on the other thereof (the rear case 3 in the present embodiment).

The locking portion 21 includes a pair of locking protrusions that protrude outward from both left and right sides of the terminal holder 4. On the other hand, the locking-subjected portion 22 includes a pair of locking recesses (not shown) provided on the left and right side surfaces of the fitting recess 7.

In the holding mechanism 20, in a state where the terminal holder 4 is fitted into the fitting recess 7 from the front side of the rear case 3, the locking portion (locking protrusion) 21 is locked to the locking-subjected portion (locking recess) 22, so that the terminal holder 4 can be held inside the fitting recess 7.

The terminal holder 4 is disposed inside the housing 2 and the rear case 3 in a state where the housing 2 and the rear case 3 are integrated.

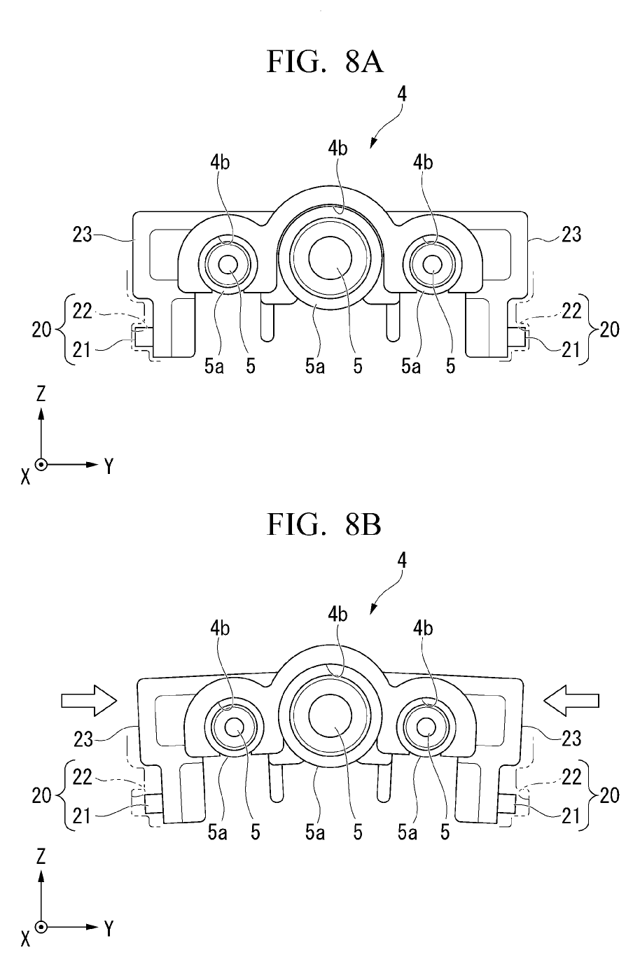

On the other hand, in the holding mechanism 20, as illustrated in FIGS. 8A and 8B, the locked state of the locking portion 21 with respect to the locking-subjected portion 22 is released by flexibly deforming the terminal holder 4.

Specifically, the terminal holder 4 is provided with manipulation portions 23 that flexibly deform the terminal holder 4 in a direction (arrow direction shown in FIG. 8B) in which the locked state of the locking portion 21 with respect to the locking-subjected portion 22 is released. A pair of manipulation portions 23 are provided at both end portions of the terminal holder 4 with the plurality of terminals 5 being interposed between the both end portions of the terminal holder 4.

In the holding mechanism 20, the terminal holder 4 can be flexibly deformed in a direction in which the locked state of the locking portion 21 with respect to the locking-subjected portion 22 is released by pressing the pair of manipulation portions 23 in a direction in which the manipulation portions 23 approach each other while the pair of manipulation portions 23 are pinched with one hand.

Regarding the holding mechanism 20, the present invention is not necessarily limited to the above-described constitution in which the locking portion 21 is provided on a side of the terminal holder 4 and the locking-subjected portion 22 is provided on a side of the rear case 3, and may have a constitution in which the locking portion 21 is provided on a side of the rear case 3 and the locking-subjected portion 22 is provided on a side of the terminal holder 4.

In addition, the locking portion 21 and the locking-subjected portion 22 are not limited to those constituted by the above-described locking protrusion and locking recess, and may have any constitution as long as the locking portion 21 is locked to the locking-subjected portion 22.

The terminal 5 is made of a metal conductor such as brass or copper and is formed in a long rod shape. On a base end side of the terminal 5, a covering portion 5a that covers a joined portion with the electric wire cord 6, a pair of flange portions 5b protruding in the radial expansion direction from the outer peripheral surface of the covering portion 5a, and an engagement recess 5c formed between the pair of flange portions 5b of the covering portion 5a are provided.

The base end side of the terminal 5 is held by the terminal holder 4 by engaging the engagement protrusion 4b with the engagement recess 5c in a state where the covering portion 5a is held inside the holding groove 4a.

On the other hand, as illustrated in FIG. 5, the tip end side of the terminal is held by the terminal holding portion 2d (housing 2) in a state of passing through the terminal holding portion 2d so as to face the inside of the cylindrical fitting portion 2b.

The electric wire cord 6 has a constitution in which an electric wire such as copper is covered with an insulating resin, for example. One end side of the electric wire cord 6 is joined to the base end side of the terminal 5 by crimping or the like. The electric wire cord 6 is disposed to extend in the front-rear direction inside the cord lead-out portion 3b (rear case 3).

On the other hand, the other end side of the electric wire cord 6 is led out from the rear to the outside of the cord lead-out portion 3b (rear case 3) through the hole portion 8. A packing 9 is attached to a rear end portion of the cord lead-out portion 3b (rear case 3) via a packing holder 10. The packing 9 is a seal member for waterproofing and is fitted inside the hole portion 8 in a state of being attached to the periphery of the electric wire cord 6.

In the connector 1 of the present embodiment, the terminal holder 4 holding the above-described terminal 5 is disposed between the housing 2 and the rear case 3. The terminal holder 4 is held inside the fitting recess 7 of the rear case 3 via the above-described holding mechanism 20.

With this constitution, in the connector 1 of the present embodiment, the terminal holder 4 is less likely to be affected by the outside, and the terminal 5 can be held in a stable state by the terminal holder 4. Furthermore, the robustness of the connector 1 can also be improved.

In addition, in the connector 1 of the present embodiment, the terminal holder 4 is held inside the fitting recess 7 in a stable state via the above-described holding mechanism 20.

With this constitution, in the connector 1 of the present embodiment, when the rear case 3 is assembled from a side (back side) opposite to the cylindrical fitting portion 2b of the housing 2, the tip end side of the terminal 5 can be inserted into the terminal holding portion 2d in a stable state, and the assembling workability of the rear case 3 with respect to the housing 2 can be improved.

On the other hand, in the connector 1 of the present embodiment, when the terminal holder 4 is removed from the rear case 3, the terminal holder 4 fitted in the fitting recess 7 can be easily removed from the rear case 3 by flexibly deforming the terminal holder 4 in a direction in which the locked state of the locking portion 21 with respect to the above-described locking-subjected portion 22 is released.

With this constitution, in the connector 1 of the present embodiment, it is possible to improve the assembling workability of the terminal holder 4 and improve the productivity.

In the above embodiment, the present invention is not necessarily limited to the constitution of the connector 1 described above, and the shapes and the like of the housing 2 and the rear case 3 can be appropriately changed. For example, the present invention can be applied not only to a straight-type connector in which the terminal 5 and the electric wire cord 6 extend in the same direction but also to an L-type connector in which the terminal 5 and the electric wire cord 6 extend in directions orthogonal to each other. In addition, the number, arrangement, and the like of the plurality of terminals 5 and electric wire cords 6 can be appropriately changed.

Although the embodiment of the present disclosure has been described and illustrated above, the above-described embodiment is illustrated as an example and is not intended to limit the scope of the present disclosure. The above-described embodiment can be implemented in various other forms, and various additions, omissions, substitutions, and modifications can be performed without departing from the gist of the disclosure.

### REFERENCE SIGNS LIST

1 Connector

2 Housing

3 Rear case

4 Terminal holder

5 Terminal

6 Electric wire cord

7 Fitting recess

8 Hole portion

9 Packing (seal member)

10 Packing holder

20 Holding mechanism

21 Locking portion

22 Locking-subjected portion

23 Manipulation portion

What is claimed is:

1. A connector comprising:
a housing including a cylindrical fitting portion that protrudes in a cylindrical shape in a direction in which the connector is fitted to a mating connector;
a rear case assembled on a side opposite to the cylindrical fitting portion of the housing;
a terminal holder disposed between the housing and the rear case;
a terminal of which a tip end side is held inside the cylindrical fitting portion in a state where a base end side of the terminal is held by the terminal holder; and
a holding mechanism that holds the terminal holder inside the rear case,
wherein the holding mechanism includes a fitting recess into which the terminal holder is fitted inside the rear case, a locking portion provided on one of the terminal holder and the rear case, and a locking-subjected portion provided on the other of the terminal holder and the rear case,
wherein the locking portion is locked to the locking-subjected portion in a state where the terminal holder is fitted into the fitting recess, and
wherein a locked state of the locking portion with respect to the locking-subjected portion is released by flexibly deforming the terminal holder.

2. The connector according to claim 1,
wherein the terminal holder is provided with a manipulation portion that flexibly deforms the terminal holder in a direction in which the locked state of the locking portion with respect to the locking-subjected portion is released.

3. The connector according to claim 2,
wherein a pair of the manipulation portions are provided at both end portions of the terminal holder with the terminal being interposed between the both end portions of the terminal holder.

4. The connector according to claim 1, further comprising
an electric wire cord having one end side joined to the base end side of the terminal and the other end side led out to the outside of the rear case through a hole portion provided in the rear case.
